(19) United States
(12) Patent Application Publication
(10) Pub. No.: US 2022/0095591 A1
(43) Pub. Date: Mar. 31, 2022

(54) Adjustable bird feeding opening control system

(71) Applicant: Sincere Greenworld Corporation, Los Angeles, CA (US)

(72) Inventors: WEI CHEN, Shanghai (CN); JINHAO ZHANG, Shanghai (CN)

(21) Appl. No.: 17/038,167

(22) Filed: Sep. 30, 2020

(51) Int. Cl. A01K 39/01; A01K 31/12

(52) U.S. Cl. CPC A01K 39/0106; A01K 31/12

(57) ABSTRACT

Adjustable bird feeding opening control system, comprises an adjusting ring, sliding toggles and a back plate; a penetrating feeding opening is arranged on the back plate, the adjusting ring is arranged in the feeding opening, a feeding mouth is arranged in a center of the adjusting ring, a sliding groove is arranged on a surface of the adjusting ring outside the feeding mouth, a limit cover is installed on the back plate on one side of the feeding opening, several sliding toggles are movably installed between the adjusting ring and the limit cover, installed sliding toggles form a ring, and inner hole of the ring is a beak feeding mouth; a bolt is arranged on one side of the sliding toggle and is fitted with a limit hole on the back plate, a release pin is arranged other side of the sliding toggle and movably inserted in the sliding groove.

### TECHNICAL FIELD

The invention relates to bird feeding, in particular to an adjustable bird feeding opening control system.

### BACKGROUND ART

Currently, the size of feeding opening for the bird feeders on the market is single and fixed. Each size of feeding opening corresponds to a specific type of bird feed. This type of bird feeding opening cannot be completely closed, and it is necessary to prevent the feed from spilling out when being filled. In addition, its single function cannot satisfy the feeding of different feeds, so consumers have to buy a variety of bird feeders.

### SUMMARY OF THE INVENTION

The purpose of the invention is to provide an adjustable bird feeding opening control system with reasonable structure and convenient operation.

To achieve the above purpose, the invention provides the technical proposal that an adjustable bird feeding opening control system comprises an adjusting ring, a sliding toggle and a back plate, wherein a penetrating feeding opening is arranged on the back plate, the adjusting ring is arranged in the feeding opening, a feeding mouth is arranged in the center of the adjusting ring, a sliding groove is arranged on the surface of the adjusting ring outside the feeding mouth, a limit cover is installed on the back plate on one side of the feeding opening, a plurality of sliding toggles are movably installed between the adjusting ring and the limit cover, the installed sliding toggles form a ring, and the inner hole of the ring is the beak feeding mouth; a bolt is arranged on one side of the sliding toggle and is fitted with a limit hole on the back plate, a release pin is arranged on the other side of the sliding toggle and is movably inserted in the sliding groove.

The bottom of the back plate extends to one side to form a bird standing rod, the bird standing rod and the back plate are in L shape by side view, and a buckle is arranged at the other end of the back plate and is connected with the pipe wall of the external feeder; a clamping slot is arranged on the back plate at the edge of the feeding mouth, and a clamping groove is arranged at the edge of the limit cover and is fitted with the clamping slot.

There are in total 4-8 sliding grooves, which are evenly distributed on the adjusting ring with the center point of the circular feeding mouth as the center and are in the shape of inclined strips.

After adopting the proposal of the invention, the size of the beak feeding mouth is adjustable by rotating the adjusting ring, which drives the convergence and divergence of the sliding toggles. By the rapid and labor-saving adjustment of opening size, the bird feeding opening can use different feeds and prevents the feed from spilling out of the feeding opening when being filled, so as achieved the purpose of a multi-purpose bird feeder.

### DESCRIPTION OF ACCOMPANIED FIGURES

FIG. 1 is a schematic diagram of the overall structure of the invention.

FIG. 2 is a cross-section diagram of FIG. 1.

FIG. 3 is a schematic diagram of installation of the adjusting ring of the invention.

FIG. 4 is a schematic diagram of the limit cover of the invention.

FIG. 5 is a front view of the sliding toggles of the invention.

FIG. 6 is a side view of the sliding toggles of the invention.

### EMBODIMENTS

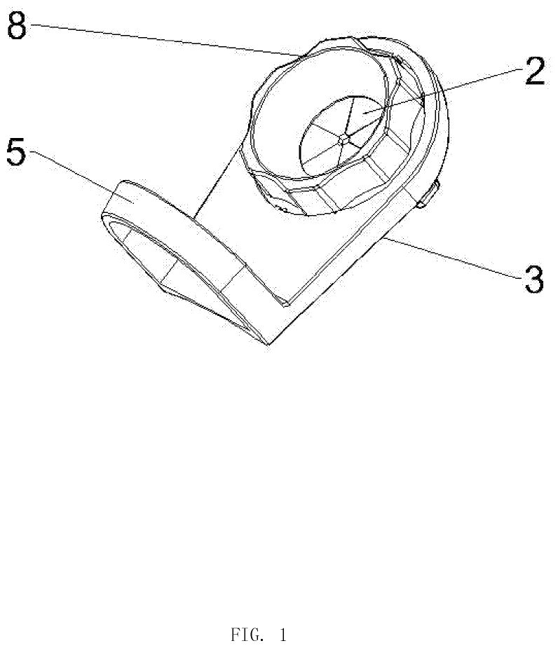

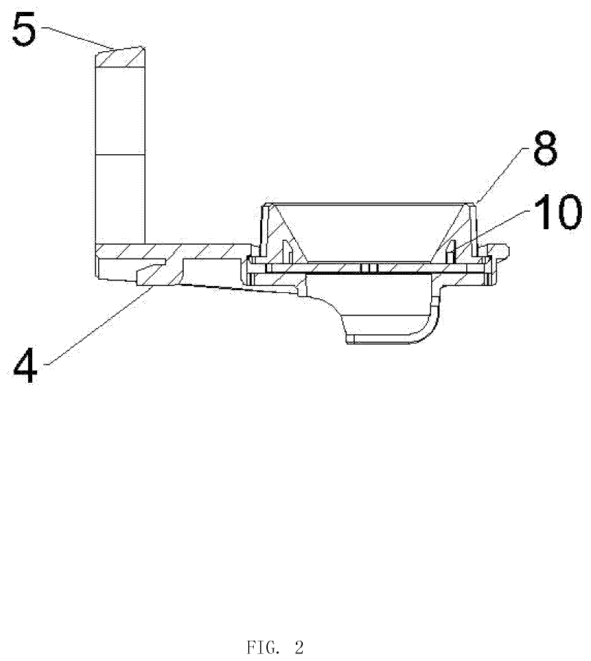

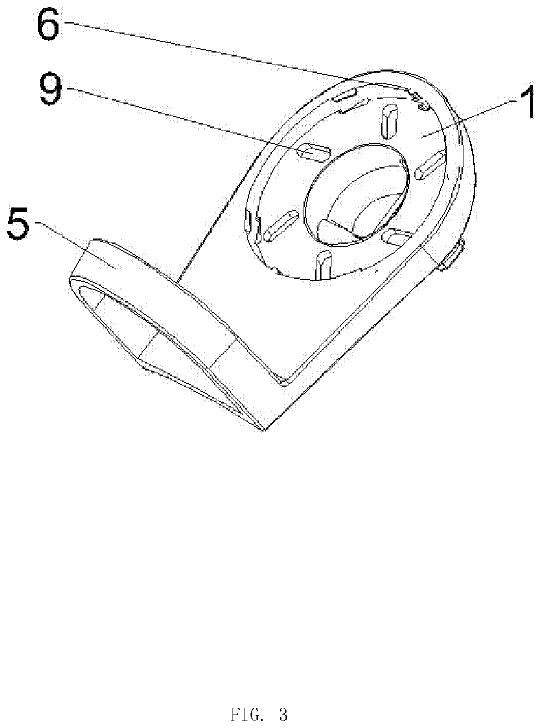

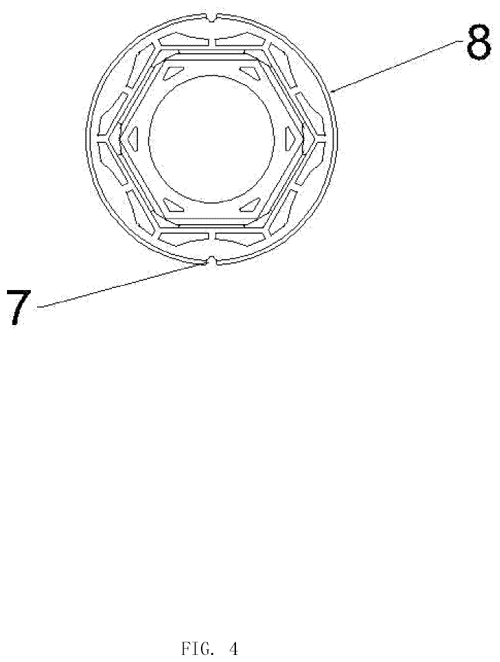

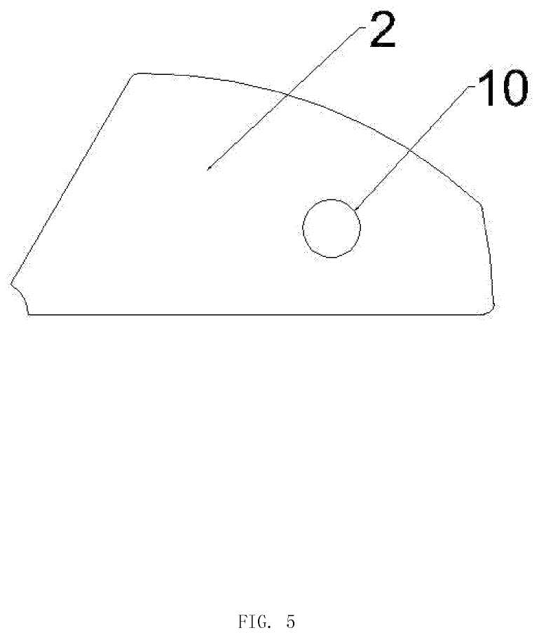

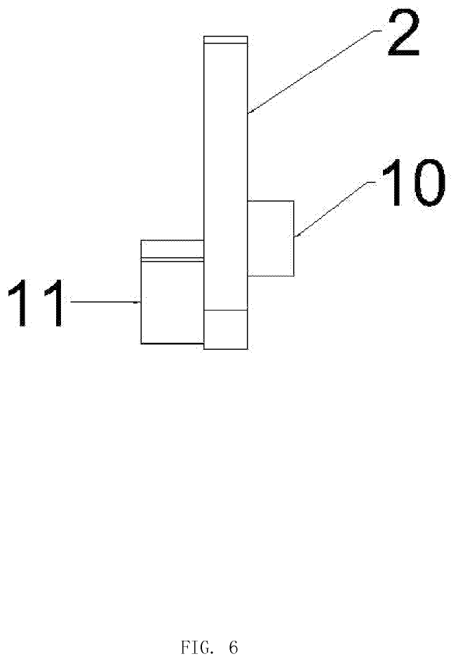

The invention is further explained in combination with all the drawings below. The preferred embodiment of the invention is as follows: according to FIG. 1 to FIG. 6, the adjustable bird feeding opening control system in the embodiment comprises an adjusting ring 1, sliding toggles 2 and a back plate 3, wherein a penetrating feeding opening is arranged on the back plate 3, the adjusting ring 1 is arranged in the feeding opening, a feeding mouth is arranged in the center of the adjusting ring 1, a sliding groove 9 is arranged on the surface of the adjusting ring 1 outside the feeding mouth, there are in total 4-8 sliding grooves 9, which are evenly distributed on the adjusting ring 1 with the center point of the circular feeding mouth as the center and are in the shape of inclined strips. a limit cover 8 is installed on the back plate 3 on one side of the feeding opening, a plurality of sliding toggles 2 are movably installed between the adjusting ring 1 and the limit cover 8, the installed sliding toggles 2 form a ring, and the inner hole of the ring is the beak feeding mouth; a bolt 10 is arranged on one side of the sliding toggle 2 and is fitted with a limit hole on the back plate 3, a release pin 11 is arranged on the other side of the sliding toggle 2 and is movably inserted in the sliding groove 9. The sliding grooves are in a strip shape, and one end is inclined by 15-25 degrees backwards to the rotation direction with the other end as the base point. The bottom of the back plate 3 extends to one side to form a bird standing rod 5, the bird standing rod 5 and the back plate 3 are in L shape by side view, and a buckle 4 is arranged at the other end of the back plate 3 and is connected with the pipe wall of the external feeder; a clamping slot 6 is arranged on the back plate 3 at the edge of the feeding mouth, and a clamping groove 7 is arranged at the edge of the limit cover 8 and is fitted with the clamping slot 6.

There are in total 6 sliding toggles 2, and the six sliding toggles are respectively clamped in the adjusting ring and the sliding grooves of the limit cover by the bolts and the release pins on the front and back. The user rotates the adjusting ring on the rotation operating panel. At the same time, the sliding grooves behind the adjusting ring are also coaxially rotated to drive the six sliding toggles for displacement. When the adjusting ring is rotated clockwise, the six sliding toggles are in mutual contact and interact to move closer to the center, so that the size of feeding opening is minimum. When the adjusting ring is rotated anticlockwise, the six sliding toggles are driven to be diverged outwards. At this point, the size of feeding opening is maximum.

The above embodiment is only the preferred embodiment of the invention, not intended to limit the scope of implementation of the invention. Therefore, any changes made in accordance with the working procedure and flow, shape and principle of the invention shall be covered within the scope of protection of the invention.

1. An adjustable bird feeding opening control system, characterized in that the adjustable bird feeding opening control system comprises an adjusting ring (1), sliding toggles (2) and a back plate (3), wherein a penetrating feeding opening is arranged on the back plate (3), the adjusting ring (1) is arranged in the feeding opening, a feeding mouth is arranged in the center of the adjusting ring (1), a sliding groove (9) is arranged on the surface of the adjusting ring (1) outside the feeding mouth, a limit cover (8) is installed on the back plate (3) on one side of the feeding opening, a plurality of sliding toggles (2) are movably installed between the adjusting ring (1) and the limit cover (8), the installed sliding toggles (2) form a ring, and the inner hole of the ring is the beak feeding mouth; a bolt (10) is arranged on one side of the sliding toggle (2) and is fitted with a limit hole on the back plate (3), a release pin (11) is arranged on the other side of the sliding toggle (2) and is movably inserted in the sliding groove (9).

2. An adjustable bird feeding opening control system according to claim 1, characterized in that the bottom of the back plate (3) extends to one side to form a bird standing rod (5), the bird standing rod (5) and the back plate (3) are in L shape by side view, and a buckle (4) is arranged at the other end of the back plate (3) and is connected with the pipe wall of the external feeder; a clamping slot (6) is arranged on the back plate (3) at the edge of the feeding mouth, and a clamping groove (7) is arranged at the edge of the limit cover (8) and is fitted with the clamping slot (6).

3. An adjustable bird feeding opening control system according to claim 1, characterized in that there are in total 4-8 sliding grooves (9), which are evenly distributed on the adjusting ring (1) with the center point of the circular feeding mouth as the center and are in the shape of inclined strips.
